(19) United States
(12) Patent Application Publication
(10) Pub. No.: US 2012/0180895 A1
(43) Pub. Date: Jul. 19, 2012

(54) Whip stop

(76) Inventor: John Frank Brattain, Vero Bch., FL (US)

(21) Appl. No.: 12/930,788

(22) Filed: Jan. 15, 2011

(51) Int. Cl. F16L 11/14

(52) U.S. Cl. 138/118.1

(57) ABSTRACT

The whip stop is made of a flexible, rust resistant galvanized sheet metal, that is preformed/bent to its permanent shape, which is a rectangular shape with four sides and a small flap which overlaps one of the sides, but is not connected to it, allowing whip stop to be flexed open and placed around a 4″×4″ wooden post, then to, on its own, snap shut protecting the post from weedeater damage. There is no folding, or unfolding needed. The user simply flexes open whip stop and whip stop snaps back to its original shape, no screws or nails are needed to hold whip stop in place.

### CROSS REFERENCE TO RELATED APP

This patent application claims benefit of related provisional application Ser. No. 61/210,359

### BACKGROUND

For years there have been mail box posts in front of houses, Since the invention of the weedeater in around 1972, the 4″×4″ wooden mailbox post has been getting whipped up by the plastic weedeater line. The grass grows next to the mailbox post and when the weedeater trims the grass around the post it can't help but strike the post with the weedeater line. This causes the post to get scared, chewed up, and widdeled away. The Whip stop is designed to eliminate this problem.

### SUMMARY

The Whip stop is designed as a strong, flexible, one size fits all device, that is easy to install. The user simply flexes open Whip stop, places it around their 4″×4″ wooden mail box post, and Whip stop snaps back to its original shape, surrounding the post, protecting it from weedeater damage.

### DETAILED DESCRIPTION OF WHIP STOP

Whip Stop is generally made of 26 gauge galvanized sheet metal. To make a Whip Stop is simple. You take a 16″−6″ strip of 26 gauge galvanized sheet metal. See FIG. 5. Next, bend the 16″ strip equally 4 times, creating a closed square with 4, 3 ¼″×6″ sides with a 1″ overlapping flap. See FIG. 2. The 1 inch flap is not connected which allows the user to flex open Whip Stop, release, and Whip Stop goes back to its original shape. See FIG. 1. There are also 2 holes drilled through the flap and adjacent side, which allows the user to fasten together with a sheet metal screw the flap and adjacent side. See FIG. 1 and FIG. 2. When completed, you should have a 6″ tall by 3 ¼″ square piece of 26 gauge galvanized sheet metal, that has a 1 inch flap over one side that can be flexed open and closed over and over again. Please see FIGS. 1 through 6.

### BRIEF DESCRIPTION OF DRAWINGS

FIG. 1 shows a Whip stop being slightly flexed open. FIG. 2 shows a Whip stop snapped shut, in its original finished state. FIG. 3 shows a whip stop flexed open, and about to be stretched over a 4″ by 4″ post.

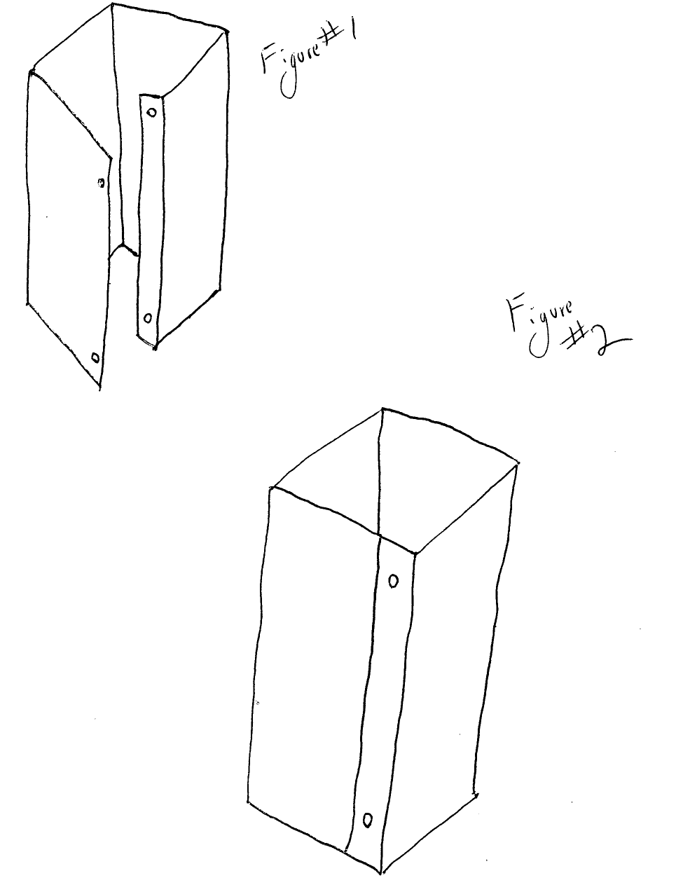

FIG. 4 shows a whip stop snapped shut protecting a 4″ by 4″ wooden post.

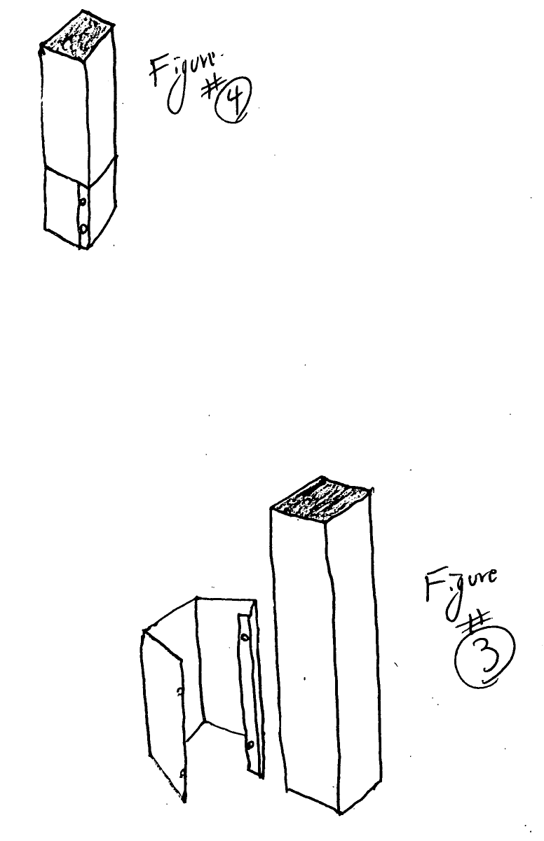

FIG. 5 shows a 16 inch long by 6 inch wide flat piece of 26 gauge galvanized sheet metal marked for bending. FIG. 6 shows a finished whip stop.

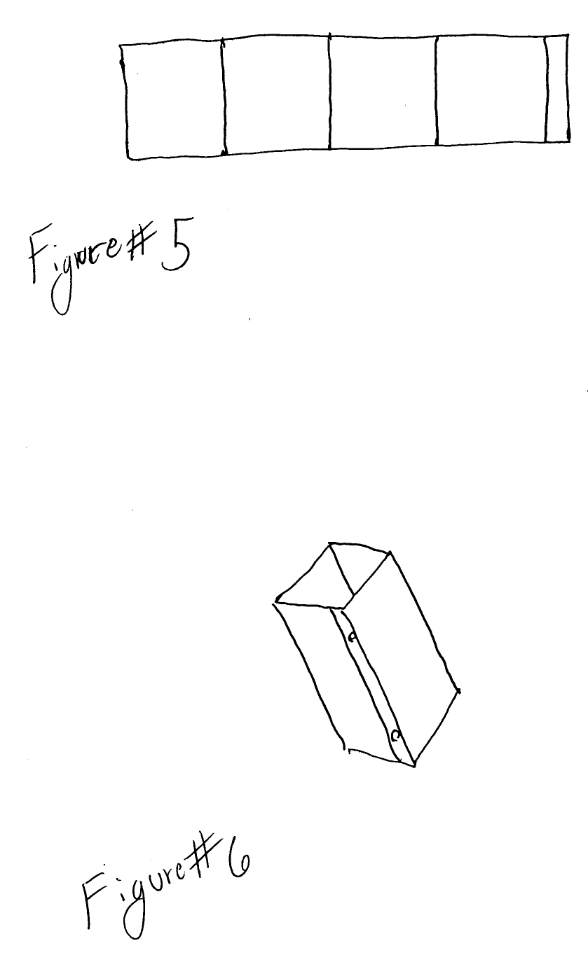

1. Whip stop claims to be a flexible, one size fits all, 4″×4″ wooden post protector that is comprised of a rust resistant, extremely flexible galvanized sheet metal, that is bent into its final shape, which is a rectangular shape consisting of four sides and a small flap which overlaps one of the sides, but is not connected to it, allowing whip stop to be flexed open, placed around a 4″×4″ wooden mail box post, then to, on its own, snap closed, back to its original shape, thus surrounding the 4×4 post, and protecting the post from weedeater damage.
